(19) United States
(12) Patent Application Publication
(10) Pub. No.: US 2008/0100065 A1
(43) Pub. Date: May 1, 2008

(54) APPARATUS FOR GENERATING ELECTRIC POWER USING OCEAN WAVE ENERGY

(76) Inventor: Yi-Ping Lee, Taichung City (TW)

Correspondence Address: DARBY & DARBY P.C., P.O. BOX 770, Church Street Station, New York, NY, 10008-0770, US

(21) Appl. No.: 11/554,189

(22) Filed: Oct. 30, 2006

(51) Int. Cl. F03B 13/12; F03B 13/10; H02P 9/04

(52) U.S. Cl. 290/53

(57) ABSTRACT

An apparatus for generating electric power using ocean wave energy includes an actuating unit that includes a cord having opposite ends connected respectively to a float riding on an ocean surface and movable vertically and reciprocally in response to ocean wave front action, and a counterweight piece distant from the float. The counterweight piece is vertically movable in a direction opposite to that of the float. An electric generating unit includes an output shaft unit rotatable in response to rotation of an input shaft unit driven by the cord in response to vertical movement of the float so as to output a mechanical rotary power output corresponding to a vertical distance traveled by the float. A generator unit is coupled to the output shaft unit to convert the mechanical rotary power output into electric power.

### BACKGROUND OF THE INVENTION

1. Field of the Invention

The invention relates to an apparatus for generating electric power using ocean wave energy.

2. Description of the Related Art

Referring to FIG. 1, a conventional system for generating electric power using ocean wave energy is shown to include a plurality of electric generating apparatuses 1, each of which is disposed above and close to an ocean surface and includes a generator 11, and two turbine units 12 coupled to the generator 11. For each apparatus 1, each turbine unit 12 has a turbine (not shown) driven by ocean waves to rotate so as to output a mechanical rotary power output to the generator 11 such that the generator 11 converts the mechanical rotary power output into electric power.

However, since the electric generating apparatuses 1 of the conventional system must be disposed close to the ocean surface, the generators 11 are easily damaged due to corrosion by seawater after a long period of use.

### SUMMARY OF THE INVENTION

Therefore, the object of the present invention is to provide an apparatus for generating electric power using ocean wave energy that can overcome the aforesaid drawback of the prior art.

According to the present invention, there is provided an apparatus for generating electric power using ocean wave energy. The apparatus comprises:

an actuating unit including
a float adapted to ride on an ocean surface so that the float is movable vertically and reciprocally in response to ocean wave front action,
a counterweight piece distant from the float and having a weight smaller than that of the float, and
a cord having opposite ends connected respectively to the float and the counterweight piece under tension such that the counterweight piece is vertically movable in a direction opposite to that of the float in response to vertical movement of the float caused by the vertical motion of the ocean surface; and

an electric generating unit including
a rotary power generating unit including an input shaft unit driven by the cord to rotate in response to the vertical movement of the float, and an output shaft unit rotatable in response to rotation of the input shaft unit so as to output a mechanical rotary power output corresponding to a vertical distance traveled by the float, and

a generator unit coupled to the output shaft unit of the rotary power generating unit to convert the mechanical rotary power output into electric power.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view illustrating a conventional apparatus for generating electric power using ocean wave energy;

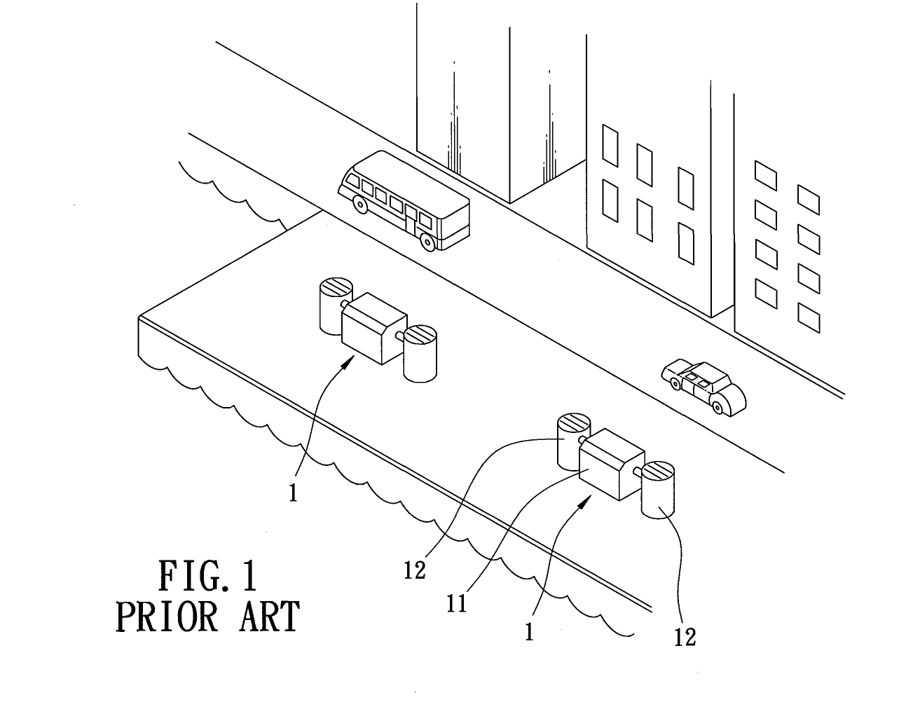

FIG. 2 is a schematic view showing the first preferred embodiment of an apparatus for generating electric power using ocean wave energy according to the present invention;

FIG. 3 is a schematic sectional view showing a float of the first preferred embodiment;

FIG. 4 is a schematic view showing a rotary power generating unit of the first preferred embodiment;

FIG. 5 is a partly sectional schematic view showing a generator unit and the rotary power generating unit of the first preferred embodiment;

FIG. 6 is a fragmentary schematic view showing the second preferred embodiment of an apparatus for generating electric power using ocean wave energy according to the present invention;

FIG. 7 is a fragmentary schematic view showing the third preferred embodiment of an apparatus for generating electric power using ocean wave energy according to the present invention;

FIG. 8 is a fragmentary schematic view showing the fourth preferred embodiment of an apparatus for generating electric power using ocean wave energy according to the present invention; and

FIG. 9 is a schematic view showing the fifth preferred embodiment of an apparatus for generating electric power using ocean wave energy according to the present invention.

### DETAILED DESCRIPTION OF THE PREFERRED EMBODIMENTS

Before the present invention is described in greater detail, it should be noted that like elements are denoted by the same reference numerals throughout the disclosure.

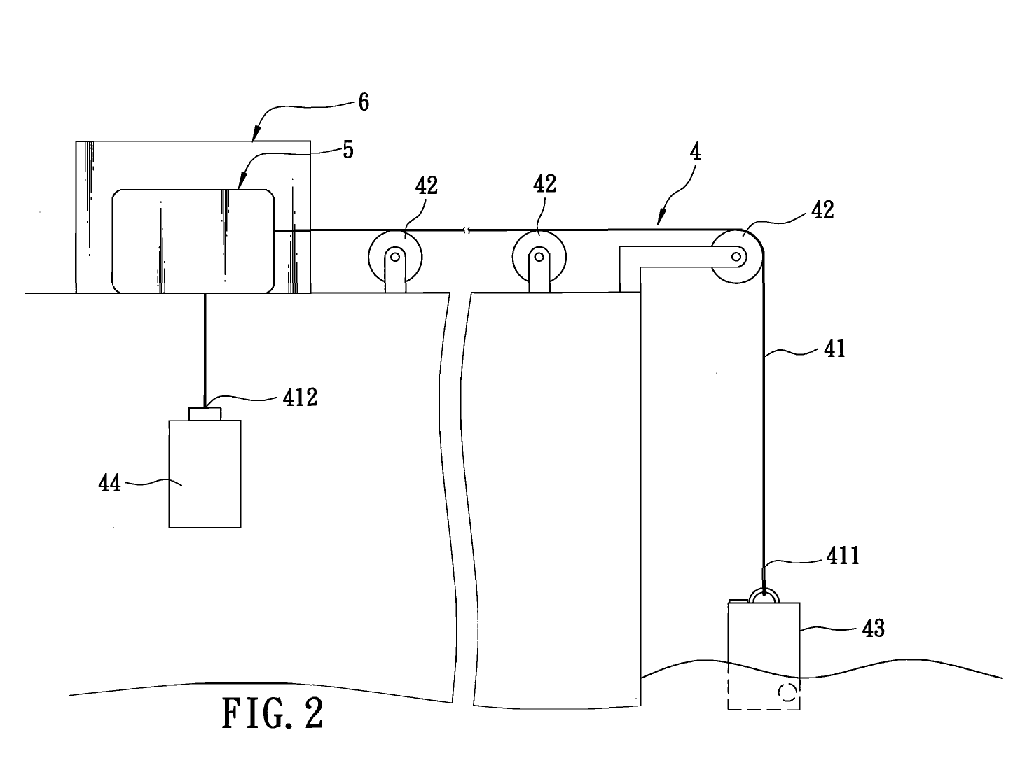

Referring to FIGS. 2 to 5, the first preferred embodiment of an apparatus for generating electric power using ocean wave energy according to the present invention is shown to include an actuating unit 4 and an electric generating unit.

The actuating unit 4 includes a float 43, a counterweight piece 44, and a cord 41.

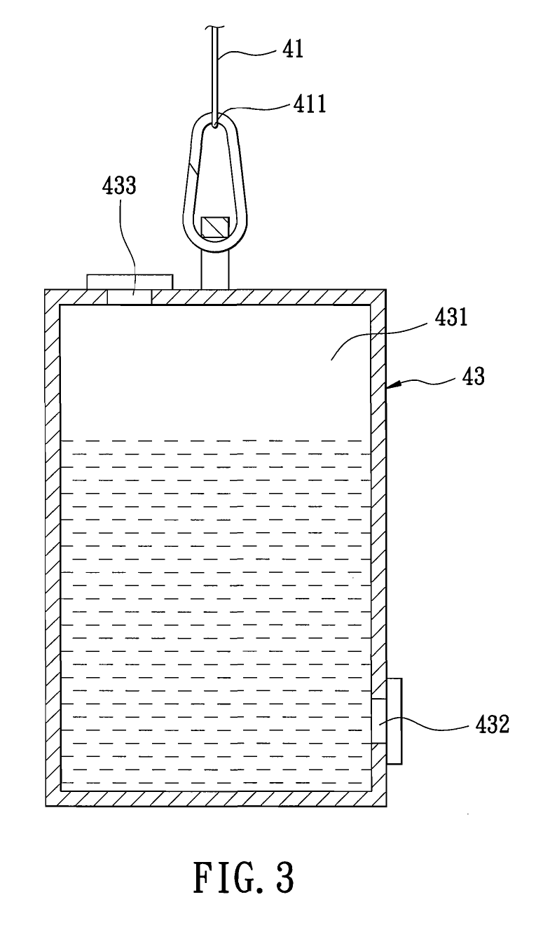

The float 43 is adapted to ride on an ocean surface so that the float 43 is movable vertically and reciprocally in response to ocean wave front action. In this embodiment, as shown in FIG. 3, the float 43 is made of plastic steel, and is configured with an inner accommodating space 431 filled with seawater therein. The float 43 has a lower end portion formed with a valve 432 in fluid communication with the inner accommodating space 431 for introducing/drawing the seawater into/from the inner accommodating space 431 in the float 43 therethrough, and an upper end portion formed with an air valve 433 in fluid communication with the inner accommodating space 431 in the float 43.

The counterweight piece 44 is distant from the float 43, and has a weight smaller than that of the float 43.

The cord 41 is configured as a steel cord, and has opposite ends 411, 412 connected respectively to the float 43 and the counterweight piece 44 under tension such that the counterweight piece 44 is vertically movable in a direction opposite to that of the float 43 in response to vertical movement of the float 43 caused by the vertical motion of the ocean surface. In this embodiment, a plurality of stationary pulleys 42 are arranged along an extension path of a part of the cord 41 for guiding and supporting the cord 41.

In this embodiment, the electric generating unit is disposed distal from the float 43. The electric generating unit includes a rotary power generating unit 5 and a generator unit 6. The rotary power generating unit 5 includes an input shaft unit driven by the cord 41 to rotate in response to the vertical movement of the float 43, and an output shaft unit rotatable in response to rotation of the input shaft unit so as to output a mechanical rotary power output corresponding to a vertical distance traveled by the float 43. The generator unit 6 is coupled to the output shaft unit of the rotary power generating unit 5 to convert the mechanical rotary power output into electric power.

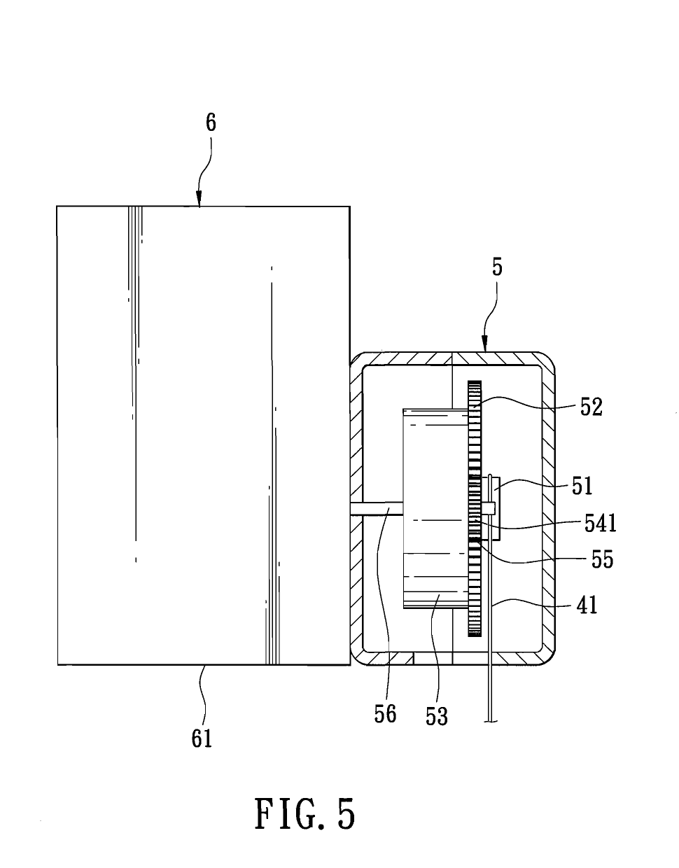

In this embodiment, the input shaft unit includes a first input shaft 50. The output shaft unit includes a first output shaft 56. The generator unit 6 includes a first generator 61 coupled to the first output shaft 56, as shown in FIG. 5.

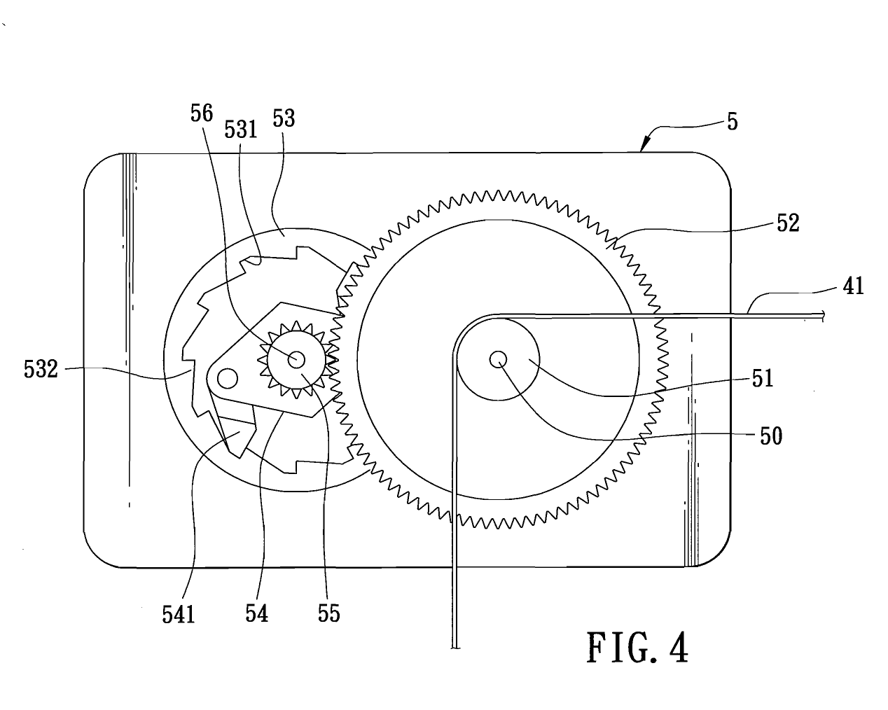

As shown in FIG. 4, the rotary power generating unit 5 further includes a first cord-mounting disk 51, a fist input gear 52, a first driven gear 55, a first rotary activating piece 54, and a first output ring 53.

The first cord-mounting disk 51 is connected coaxially and fixedly to the first input shaft 50 of the input shaft unit. The cord 41 extends around and is in frictional contact with the first cord-mounting disk 51.

The first input gear 52 is connected coaxially and fixedly to the first input shaft 50 of the input shaft unit. The first driven gear 55 is sleeved rotatably on the first output shaft 56 of the output shaft unit, and meshes with the first input gear 52 such that the first driven gear 55 is driven by the first input gear 52 to rotate about the first output shaft 56 of the output shaft unit.

The first rotary activating piece 54 is connected fixedly to the first driven gear 55 such that the first rotary activating piece 54 is rotatable about the first output shaft 56 of the output shaft unit together with the first driven gear 55. The first rotary activating piece 54 has a fixed pawl 541.

The first output ring 53 is connected coaxially and fixedly to the first output shaft 56 of the output shaft unit, and has an inner annular surface 531 formed with a plurality of ratchet teeth 532. In this embodiment, when the float 43 moves upwardly as a result of upward motion of the ocean surface, the ratchet teeth 532 of the first output ring 53 are disengaged from the pawl 541 of the first rotary activating piece 54 such that an assembly of the first output shaft 56 of the output shaft unit and the first output ring 53 does not rotate, thereby ceasing the mechanical rotary power output at the first output shaft 56 of the output shaft unit. On the other hand, when the float 43 moves downwardly as a result of downward motion of the ocean surface, the ratchet teeth 532 of the first output ring 53 engage the pawl 541 of the first rotary activating piece 54 such that the assembly of the first output shaft 56 of the output shaft unit and the first output ring 53 is driven by the first rotary activating piece 54 to rotate, thereby outputting the mechanical rotary power output at the first output shaft 56 of the output shaft unit.

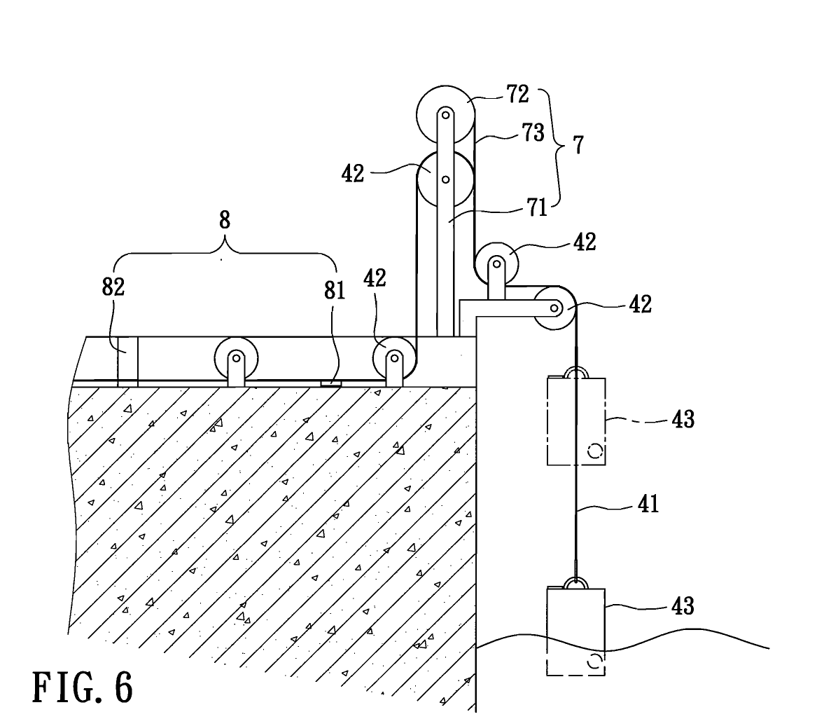

FIG. 6 illustrates the second preferred embodiment of an apparatus for generating electric power using ocean wave energy according to this invention, which is a modification of the first preferred embodiment. In this embodiment, the apparatus further includes a detecting unit 8 and a raising unit 7.

The detecting unit 8 detects the distance traveled upwardly by the float 43 during use. In this embodiment, the detecting unit 8 includes an indicator 81 mounted fixedly on the cord 41, and a detector 82 for detecting movement of the indicator 81 that corresponds to the movement of the float 43 and for outputting a control signal upon detecting that a distance traveled by the indicator 81 is greater than a predetermined value. It is noted that the distance traveled by the indicator 81 corresponds to that of the float 43.

In this embodiment, the raising unit 7 is connected electrically to the detector 82 of the detecting unit 8, and includes a support frame 71 fixed uprightly on seacoast, a roller 72 mounted rotatably on the support frame 71, and a cord 73 having opposite ends connected respectively to the float 43 and the roller 72. As such, when the raising unit 7 receives the control signal from the detector 82, the roller 72 is operated to roll up the cord 71 so as to raise the float 43 away from the ocean surface, thereby preventing damage to the float 43 when large waves occur. On the other hand, when the detector 82 detects that the distance traveled by the indicator 81 is greater than the predetermined value, the valves 432, 433 shown in FIG. 5 are operated to open for removal of the seawater in the float 43, thereby facilitating raising of the float 43.

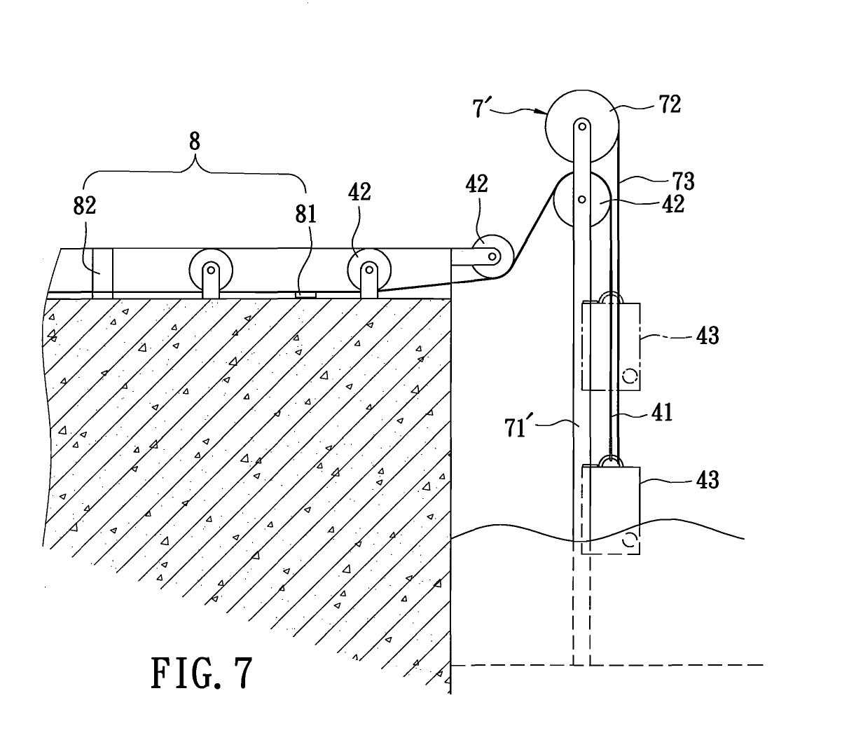

FIG. 7 illustrates the third preferred embodiment of an apparatus for generating electric power using ocean wave energy according to this invention, which is a modification of the second preferred embodiment. Unlike the second preferred embodiment, the support frame 71′ of the raising unit 7′ is fixed uprightly on the seabed.

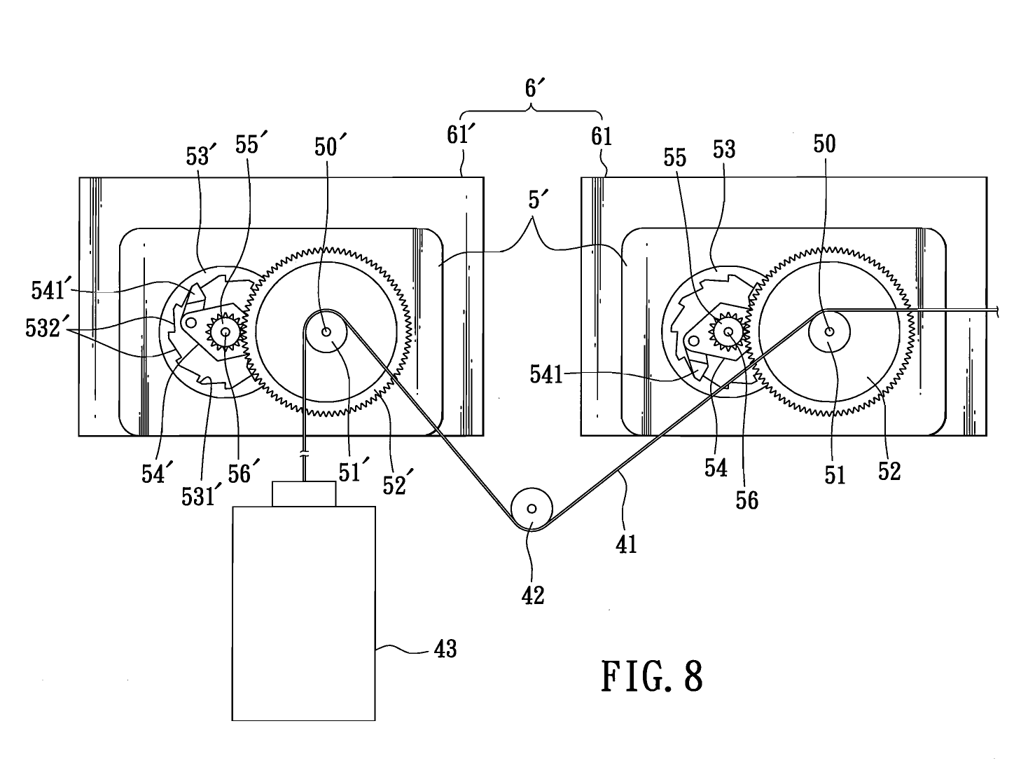

FIG. 8 illustrates the fourth preferred embodiment of an apparatus for generating electric power using ocean wave energy according to this invention, which is a modification of the first preferred embodiment. In this embodiment, the input shaft unit of the rotary power generating unit 5′ further includes a second input shaft 50′. The output shaft unit of the rotary power generating unit 5′ further includes a second output shaft 56′. The generator unit 6′ further includes a second generator 61′ coupled to the second output shaft 56′.

The rotary power generating unit 5′ of the electric generating unit further includes a second cord-mounting disk 51′, a second input gear 52′, a second driven gear 55′, a second rotary activating piece 54′, and a second output ring 53′.

The second cord-mounting disk 51′ is connected coaxially and fixedly to the second input shaft 50′. The cord 41 also extends around and is in frictional contact with the second cord-mounting disk 51′.

The second input gear 52′ is connected coaxially and fixedly to the second input shaft 50′.

The second driven gear 55′ is sleeved rotatably on the second output shaft 56′, and meshes with the second input gear 52′ such that the second driven gear 55′ is driven by the second input gear 52′ to rotate about the second output shaft 56′.

The second rotary activating piece 54′ is connected fixedly to the second driven gear 55′ such that the second rotary activating piece 54′ is rotatable about the second output shaft 56′ together with the second driven gear 55′. The second rotary activating piece 54′ has a fixed pawl 541′.

The second output ring 53′ is connected coaxially and fixedly to the second output shaft 56′, and has an inner surface 531′ formed with a plurality of ratchet teeth 532′. In this embodiment, when the float 43 moves downwardly as a result of the downward motion of the ocean surface, the ratchet teeth 532′ of the second output ring 53′ are disengaged from the pawl 541′ of the second rotary activating piece 54′ such that an assembly of the second output shaft 56′ and the second output ring 53′ does not rotate, thereby ceasing the mechanical rotary power output at the second output shaft 56′. However, at the same time, the mechanical rotary power output corresponding to downward movement of the float 43 is outputted at the first output shaft 56. On the other hand, when the float 43 moves upwardly as a result of upward motion of the ocean surface, the ratchet teeth 532′ of the second output ring 53′ engage the pawl 541′ of the second rotary activating piece 54′ such that the assembly of the second output shaft 56′ and the second output ring 53′ is driven by the second rotary activating piece 54′ to rotate, thereby outputting the mechanical rotary power output corresponding to upward movement of the float 43 at the second output shaft 56′. However, at the same time, the mechanical rotary power output corresponding to upward movement of the float 43 is not outputted at the first output shaft 56.

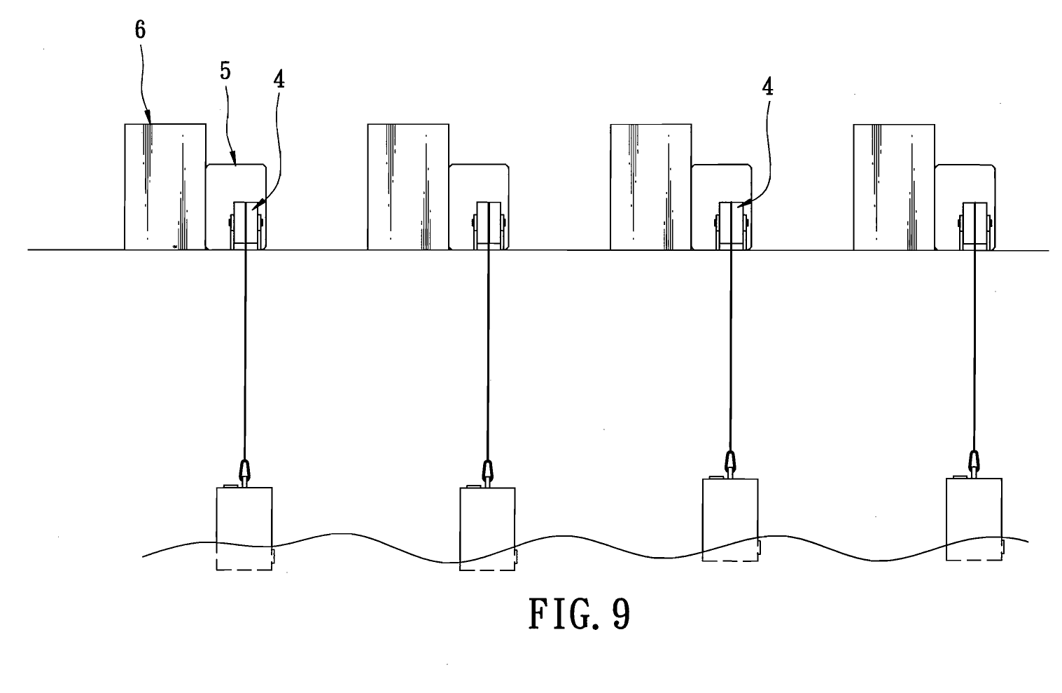

FIG. 9 illustrates the fifth preferred embodiment of an apparatus for generating electric power using ocean wave energy according to this invention, which is a modification of the first preferred embodiment. In this embodiment, the apparatus includes a plurality of the actuating units 4, and a plurality of the electric generating units.

In such a configuration, since the electric generating units can be installed on locations far from the seacoast, damage to the electric generating units resulting from corrosion by seawater can be minimized.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An apparatus for generating electric power using ocean wave energy comprising:
an actuating unit including
a float adapted to ride on an ocean surface so that said float is movable vertically and reciprocally in response to ocean wave front action,
a counterweight piece distant from said float and having a weight smaller than that of said float, and
a cord having opposite ends connected respectively to said float and said counterweight piece under tension such that said counterweight piece is vertically movable in a direction opposite to that of said float in response to vertical movement of said float caused by the vertical motion of the ocean surface; and
an electric generating unit including
a rotary power generating unit including an input shaft unit driven by said cord to rotate in response to the vertical movement of said float, and an output shaft unit rotatable in response to rotation of said input shaft unit so as to output a mechanical rotary power output corresponding to a vertical distance traveled by said float, and
a generator unit coupled to said output shaft unit of said rotary power generating unit to convert the mechanical rotary power output into electric power.

2. The apparatus as claimed in claim 1, wherein said float is configured with an inner accommodating space filled with seawater therein.

3. The apparatus as claimed in claim 2, wherein said float has a lower end portion formed with a valve in fluid communication with said inner accommodating space in said float for introducing/drawing the seawater into/from said inner accommodating space in said float therethrough.

4. The apparatus as claimed in claim 2, wherein said float has an upper end portion formed with an air valve in fluid communication with said inner accommodating space in said float.

5. The apparatus as claimed in claim 1, wherein said float is made of plastic steel.

6. The apparatus as claimed in claim 1, wherein said cord is configured as a steel cord.

7. The apparatus as claimed in claimed in claim 1, wherein:
said input shaft unit of said rotary power generating unit includes a first input shaft;
said output shaft unit of said rotary power generating unit includes a first output shaft;
said generator unit of said electric generating unit includes a first generator coupled to said first output shaft; and
said rotary power generating unit of said electric generating unit further includes:
a first cord-mounting disk connected coaxially and fixedly to said first input shaft of said input shaft unit, said cord extending around and being in frictional contact with said first cord-mounting disk;
a first input gear connected coaxially and fixedly to said first input shaft of said input shaft unit;
a first driven gear sleeved rotatably on said first output shaft of said output shaft unit and meshing with said first input gear such that said first driven gear is driven by said first input gear to rotate about said first output shaft of said output shaft unit;
a first rotary activating piece connected fixedly to said first driven gear such that said first rotary activating piece is rotatable about said first output shaft of said output shaft unit together with said first driven gear, said first rotary activating piece having a fixed pawl; and
a first output ring connected coaxially and fixedly to said first output shaft of said output shaft unit and having an inner annular surface formed with a plurality of ratchet teeth that are disengaged from said pawl of said first rotary activating piece when said float moves upwardly as a result of upward motion of the ocean surface such that an assembly of said first output shaft of said output shaft unit and said first output ring does not rotate, thereby ceasing the mechanical rotary power output at said first output shaft of said output shaft unit, said ratchet teeth of said first output ring engaging said pawl of said first rotary activating piece when said float moves downwardly as a result of downward motion of the ocean surface such that the assembly of said first output shaft of said output shaft unit and said first output ring is driven by said first rotary activating piece to rotate, thereby outputting the mechanical rotary power output corresponding to downward movement of said float at said first output shaft of said output shaft unit.

8. The apparatus as claimed in claimed in claim 7, wherein:
said input shaft unit of said rotary power generating unit further includes a second input shaft;
said output shaft unit of said rotary power generating unit further includes a second output shaft;
said generator unit of said electric generating unit further includes a second generator coupled to said second output shaft; and
said rotary power generating unit of said electric generating unit further includes:
a second cord-mounting disk connected coaxially and fixedly to said second input shaft of said input shaft unit, said cord extending around and being in frictional contact with said second cord-mounting disk;
a second input gear connected coaxially and fixedly to said second input shaft of said input shaft unit;
a second driven gear sleeved rotatably on said second output shaft and meshing with said second input gear such that said second driven gear is driven by said second input gear to rotate about said second output shaft of said output shaft unit;
a second rotary activating piece connected fixedly to said second driven gear such that said second rotary activating piece is rotatable about said second output shaft together with said second driven gear, said second rotary activating piece having a fixed pawl; and
a second output ring connected coaxially and fixedly to said second output shaft of said output shaft unit and having an inner annular surface formed with a plurality of ratchet teeth that are disengaged from said pawl of said second rotary activating piece when said float moves downwardly as a result of the downward motion of the ocean surface such that an assembly of said second output shaft of said output shaft unit and said second output ring does not rotate, thereby ceasing the mechanical rotary power output at said second output shaft of said output shaft unit, said ratchet teeth of said second output ring engaging said pawl of said second rotary activating piece when said float moves upwardly as a result of the upward motion of the ocean surface such that the assembly of said second output shaft of said output shaft unit and said second output ring is driven by said second rotary activating piece to rotate, thereby outputting the mechanical rotary power output corresponding to the upward movement of said float at said second output shaft of said output shaft unit.

9. The apparatus as claimed in claim 1, further comprising:
a detecting unit for detecting the distance traveled upwardly by said float; and
a raising unit connected to said float for raising said float away from the ocean surface when said detecting unit detects that the amount of the upward movement of said float is greater than a predetermined value.
